(19) United States
(12) Patent Application Publication
(10) Pub. No.: US 2006/0293210 A1
(43) Pub. Date: Dec. 28, 2006

(54) Desalting of hydrocarbons

(75) Inventors: Pedro Ortega, Los Teques (VE); Manuel Colina, Caracas (VE); Rafael Fernández, Edo-Miranda (VE)

Correspondence Address: BACHMAN & LAPOINTE, P.C., 900 CHAPEL STREET, SUITE 1201, NEW HAVEN, CT, 06510, US

(73) Assignee: INTEVEP, S.A., CARACAS (VE)

(21) Appl. No.: 11/166,029

(22) Filed: Jun. 23, 2005

(51) Int. Cl. C11D 17/08

(52) U.S. Cl. 510/421

(57) ABSTRACT

A composition for desalting a hydrocarbon includes a hydrophilic gel component and a polyoxyalkene ethoxylated surfactant component. A method is also provided. Preferred gel component includes hydrated polyanionic cellulose, and preferred surfactant component includes polyoxypropylene ethoxylated surfactant.

### BACKGROUND OF THE INVENTION

The invention relates to treatment of hydrocarbons and, more particularly, to a composition and method for breaking and desalting of hydrocarbon emulsion, particularly a heavy hydrocarbon.

Removal of salt from hydrocarbon products is an important step in the refining of hydrocarbons to useful end products. One method which has been used for removing salt from hydrocarbons is to form an emulsion of the hydrocarbon with an aqueous or water phase, at which point the salts transfer into the aqueous phase, and then to break the emulsion so that the removal of the water phase removes salt as well.

Once the emulsion is formed and salt transferred, breaking of the emulsion is then desirable.

Conventional methods for breaking such emulsions involve the use of materials which are not biodegradable and, furthermore, can be toxic.

It is the primary object of the present invention to provide a composition and method for use in breaking and desalting a hydrocarbon emulsion, which does not contain these harmful products.

It is the further object of the present invention to provide a composition and method which are more effective than known compositions.

Other objects and advantages of the present invention will appear herein below.

### SUMMARY OF THE INVENTION

In accordance with the present invention, the foregoing objects and advantages have been readily attained.

According to the invention, a composition is provided for desalting a hydrocarbon, which composition comprises a hydrophilic gel component, preferably hydrated polyanionic cellulose, and a polyoxyalkene ethoxylated surfactant component, preferably polyoxypropylene ethoxylated surfactant.

In further accordance with the invention, a method is provided for removing salt from a hydrocarbon emulsion, which method comprises the steps of providing a hydrocarbon emulsion containing salt, providing a composition comprising a hydrophilic gel component and a polyoxyalkene ethoxylated surfactant component, and dosing the hydrocarbon emulsion with the composition to break the emulsion into a hydrocarbon phase and a water phase, and to desalt the hydrocarbon phase.

### BRIEF DESCRIPTION OF THE DRAWINGS

A detailed description of preferred embodiments of the present invention follows, with reference to the attached drawings, wherein:

FIG. 1 illustrates the structure of a preferred hydrophilic gel component according to the invention;

FIG. 2 illustrates the structure of a preferred polyoxyalkene ethoxylated surfactant component in accordance with the present invention; and

FIG. 3 illustrates results obtained using compositions according to the present invention and using prior art compositions.

### DETAILED DESCRIPTION

The present invention relates to a composition and method using same in which hydrocarbons are desalted directly from an emulsion of water in the hydrocarbon phase, by breaking the emulsion and separation of phases.

The composition used to accomplish this contains biodegradable components, and materials which provide a particularly desirable result.

In accordance with the invention, the composition of the present invention comprises a first component preferably in the form of a hydrophilic gel component, and a second component preferably in the form of a polyoxyalkene ethoxylated surfactant component.

The hydrophilic gel component advantageously serves as a driver for draining the emulsified drops from the emulsion. This component provides water affinity to help drain water drops or droplets from the emulsion. A preferred hydrophilic gel component is hydrated polyanionic cellulose.

The surfactant component advantageously serves as an agent for affecting the interfacial characteristics between the hydrocarbon and water phases and breaking the emulsion. A preferred polyoxyalkene ethoxylated surfactant component is polyoxypropylene ethoxylated surfactant.

These components can be provided in a composition which, when added to a hydrocarbon emulsion, serves to directly break the hydrocarbon emulsion into a hydrocarbon phase and a water phase and, in consequence, to desalt the hydrocarbon phase. Advantageously, these components are biodegradable and non-toxic, and are therefore environmentally friendly.

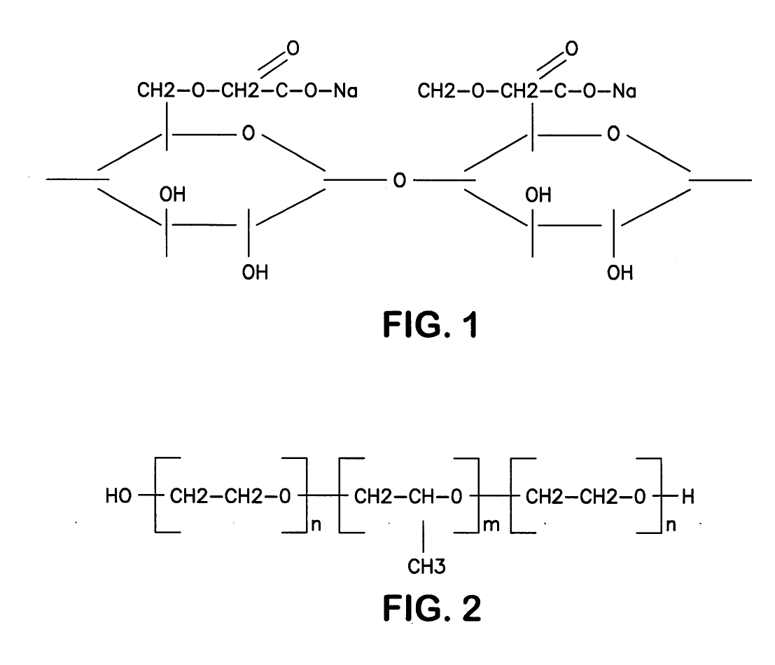

FIG. 1 shows the structure of a preferred hydrophilic gel component, specifically, hydrated polyanionic cellulose. Of course, this is one preferred hydrophilic gel component, and other structures can be used within the broad scope of the present invention.

FIG. 2 illustrates the structure of a preferred polyoxyalkene ethoxylated surfactant component, in this instance polyoxypropylene ethoxylated surfactant. This, too, is a preferred composition for use in accordance with the present invention. It should be appreciated, however, that other surfactant components can be used within the broad scope of the present invention.

In accordance with the invention, the additive is included in an emulsion in amounts sufficient to produce an internal composition of hydrophilic gel component in water phase in an amount between about 3% and about 7% based upon weight of the water phase.

In accordance with the present invention, the composition and method of using same can be utilized for removing salt from any particular hydrocarbon. The method of the present invention is particularly well suited, however, to heavy hydrocarbons wherein treatment stages can be made difficult by the viscous nature of same. The process of forming such a heavy hydrocarbon into an emulsion makes the hydrocarbon more flowable and handlable for use in subsequent treatments such as that of the present invention.

The additive of the present invention includes the hydrated polyanionic cellulose in effective amounts and preferably up to about 30% wt, and the polyoxypropylene ethoxylated surfactant component also in effective amounts and up to about 30% wt. Water or isopropyl alcohol is preferably the balance component.

The additive also preferably contains the gel and surfactant components in substantially equal quantities. This additive was tested using 3% wt and 3.5% wt amounts of gel component, as internal composition in the water phase. These two compositions were tested against prior art compositions, specifically, Arbreak1501 and EC2361A, both of which are generic demulsifiers of water in oil emulsions, from Nalco Chemical Company.

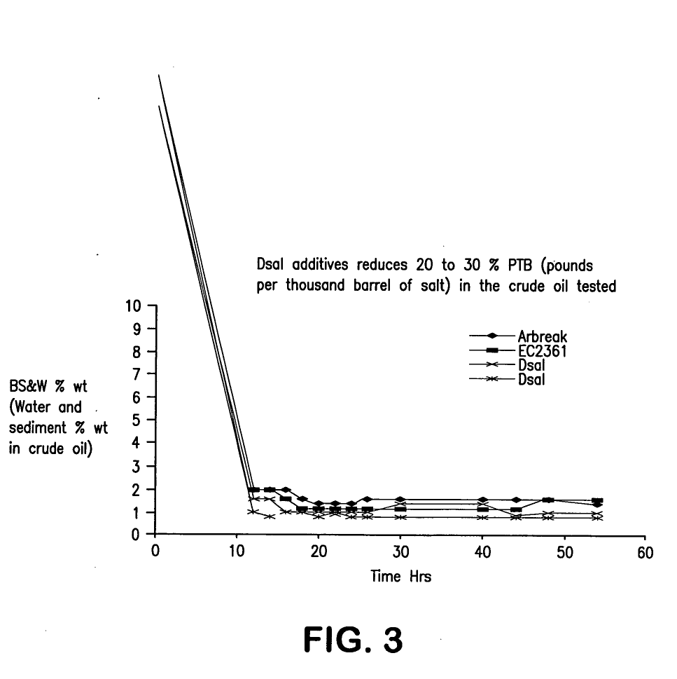

These products were tested with the same hydrocarbon, and the results are shown in FIG. 3.

As shown in FIG. 3, the compositions in accordance with the present invention, identified in the Figure as Dsal, provide slightly superior results to the conventional products which were tested. In addition, however, the composition in accordance with the present invention is biodegradable and non-toxic, as compared to the prior art products which are both toxic and non-biodegradable.

In accordance with the present invention, it should readily be appreciated that a composition has been provided, and a method has been provided for using same, wherein hydrocarbons can be desalted without substantial formation of non-biodegradable by-products. Further, the results obtained using the composition in accordance with the present invention are improved over the results obtained using prior art materials.

This invention may be embodied in other forms or carried out in other ways without departing from the spirit or essential characteristics thereof. The present embodiment is therefore to be considered as in all respects illustrative and not restrictive, the scope of the invention being indicated by the appended claims, and all changes which come within the meaning and range of equivalency are intended to be embraced therein.

What is claimed is:

1. A composition for desalting a hydrocarbon from a hydrocarbon emulsion, comprising:
a hydrophilic gel component; and
a polyoxyalkene ethoxylated surfactant component, wherein the hydrophilic gel component provides water affinity to drain water droplets from the emulsion, and the polyoxyalkene ethoxylated surfactant component provides driving force to modify interfacial properties of the emulsion and to break same.

2. The composition space of claim 1, wherein the hydrophilic gel component comprises prehydrated polyanionic cellulose.

3. The composition of claim 2, wherein the surfactant component comprises a polyoxypropylene ethoxylated surfactant.

4. The composition of claim 1, further comprising a balance component selected from the group consisting of water, isopropanol and mixtures thereof.

5. The composition of claim 1, wherein the composition contains the gel component in an amount up to about 30% based on weight of the composition, and wherein the composition also includes the surfactant component in an amount up to about 30% based on weight of the composition.

6. The composition of claim 1, wherein the composition contains substantially equal amounts of gel component and surfactant component.

7. The composition of claim 1, wherein the gel component has a structure substantially as shown in FIG. 1.

8. The composition of claim 1, wherein the surfactant component has a structure substantially as shown in FIG. 2.

9. A method for removing salt from a hydrocarbon, comprising the steps of:
providing an emulsion comprising a water phase, a hydrocarbon phase and salt;
providing a composition comprising a hydrophilic gel component and a polyoxyalkene ethoxylated surfactant component; and
adding the composition to the emulsion so as to break the emulsion and desalt the hydrocarbon phase.

10. The method of claim 9, wherein the gel component comprises prehydrated polyanionic cellulose.

11. The method of claim 10, wherein the surfactant component comprises a polyoxypropylene ethoxylated surfactant.

12. The method of claim 9, wherein the surfactant component comprises a polyoxypropylene ethoxylated surfactant.

13. The method of claim 9, wherein the composition contains the gel component in an amount up to about 30% based on weight of the composition, and wherein the composition also includes the surfactant component in an amount up to about 30% based on weight of the composition.

14. The method of claim 9, wherein the composition contains substantially equal amounts of gel component and surfactant component.

15. The method of claim 9, wherein the gel component has a structure substantially as shown in FIG. 1.

16. The method of claim 9, wherein the surfactant component has a structure substantially as shown in FIG. 2.
